(19) United States
(12) Patent Application Publication
(10) Pub. No.: US 2006/0082673 A1
(43) Pub. Date: Apr. 20, 2006

(54) Camera module and method of fabricating the same

(76) Inventors: Dong-Han Kim, Gyeonggi-do (KR); Sa-Yoon Kang, Seoul (KR); Woo-Ik Jang, Seoul (KR)

Correspondence Address: MARGER JOHNSON & MCCOLLOM, P.C., 210 SW MORRISON STREET, SUITE 400, PORTLAND, OR, 97204, US

(21) Appl. No.: 11/254,380

(22) Filed: Oct. 19, 2005

(30) Foreign Application Priority Data
Oct. 20, 2004 (KR) 2004-83971

(51) Int. Cl. H04N 5/225

(52) U.S. Cl. 348/340

(57) ABSTRACT

In one embodiment, a camera module includes a lens holder and a flexible printed circuit board, both directly attachable on an image recognition chip without using a PCB. Thus, cost can be reduced by at least the price of the PCB. Also, a size of the camera module can be reduced. A method of fabricating the camera module of embodiments of the present invention can exclude chip attaching and wire bonding processes. Thus, the camera module can be fabricated within a short time using a simple assembling process.

This application claims the priority of Korean Patent Application No. 10-2004-0083971, filed on Oct. 20, 2004, in the Korean Intellectual Property Office, the disclosure of which is incorporated herein in its entirety by reference.

### BACKGROUND OF THE INVENTION

1. Field of the Invention

The present invention relates to an image recognition semiconductor camera module (hereinafter referred to as a camera module) adopted in a mobile phone or a digital camera.

2. Description of the Related Art

Use of digital cameras is increasing along with internet video communication and the like. Also, with the increasing popularity of next generation mobile communication, compact camera modules are increasingly required to use compact personal digital assistants (PDAs) in video communication or the like. In other words, there is a greatly increasing demand for subminiature camera modules directly and indirectly related to high- and multi-function digital cameras. In particular, cameras adapted in mobile phones used for mobile communication employ compact camera modules. Thus when a camera module is developed, a very important consideration is a size of the camera module.

FIG. 1 illustrates a conventional camera module. An image recognition chip 20 is attached on an upper surface of a printed circuit board (PCB) 10 used as a substrate. Wire patterns of the PCB 10 are bonded to pads of the image recognition chip 20 by wires 30 to electrically couple the PCB 10 to the image recognition chip 20. A lens holder 50 including a lens 40 is placed on a predetermined surface of the PCB 10 in the vicinity of the bonded wires 30. An infrared (IR) cut filter 60 is attached to the lens holder 50 to transmit only a visible part of the electromagnetic spectrum.

A method of fabricating such a camera module will now be described. The image recognition chip 20 is attached on the PCB 10. Next, the PCB 10 is bonded to the image recognition chip 20 using the wires 30 to electrically couple the PCB 10 to the image recognition chip 20. Thereafter, the lens holder 50, in which the lens 40 and IR cut filter 60 are mounted, is housed to protect the image recognition chip 20.

As shown in FIG. 1, a flexible PCB (FPCB) 70 is mainly used to couple the PCB 10 to external electronics (not shown). The FPCB 70 is bonded to the PCB 10 using an anisotropic conductive film 80. An image is received through the lens 40, the IR cut filter 60, and the image recognition chip 20. Next, the image recognition chip 20 converts the image into an electrical signal. Thereafter, the electrical signal is transmitted via the wires 30, the PCB 10, and the FPCB 70.

In FIG. 1, the conventional camera module includes only the image recognition chip 20. However, a camera module may include an additional chip as well as the image recognition chip 20.

Unfortunately, as shown in FIG. 1, the PCB 10 must be larger than the lens holder 50 to couple the FPCB 70 to the PCB 10. This causes the size of the conventional camera module to increase. In addition, a space for bonding the wires 30 is required, also causing the size of the camera module to increase. Thus there is a need for a smaller camera module.

### SUMMARY

Embodiments of the present invention provide a camera module which can have a decreased size.

Embodiments of the present invention also provide a method of fabricating a camera module using a simple assembling process.

According to an embodiment of the present invention, there is provided a camera module including: a lens holder including a lens; an image recognition chip including an upper surface attached to a lower end of the lens holder; and a flexible printed circuit board attached on the upper surface or a lower surface of the image recognition chip to extend in a direction outside the lens holder and the image recognition chip.

According to another embodiment of the present invention, there is provided a method of fabricating a camera module, including: attaching a flexible printed circuit board on an upper or lower surface of an image recognition chip to extend in a direction outside the image recognition chip; and preparing a lens holder including a lens and attaching a lower end of the lens holder on the upper surface of the image recognition chip. Alternatively, the lens holder including a lens may be prepared and a lower end of the lens holder may be attached on the upper surface of the image recognition chip. Next, the flexible printed circuit board may be attached on the upper or lower surface of the image recognition chip to extend in the direction outside the image recognition chip.

According to an embodiment of the present invention, in the camera module, the lens holder is attached on the image recognition chip without using a printed circuit board. Also, the flexible printed circuit board can be directly attached to the image recognition chip. As a result, a size of the camera module can be reduced, and a process of assembling the camera module can be simplified.

### BRIEF DESCRIPTION OF THE DRAWINGS

The above and other features and advantages of the present invention will become more apparent by describing in detail exemplary embodiments thereof with reference to the attached drawings, in which:

FIG. 1 is a cross-sectional view of a conventional camera module;

FIG. 2 is a cross-sectional view of a camera module, according to an embodiment of the present invention;

FIG. 3 is a top view of an image recognition chip used in the camera module shown in FIG. 2;

FIG. 4 is a cross-sectional view of a camera module, according to another embodiment of the present invention;

FIG. 5 is a cross-sectional view of a camera module, according to still another embodiment of the present invention;

FIG. 6 is a cross-sectional view of a camera module, according to yet another embodiment of the present invention; and

FIG. 7 is a cross-sectional view of a camera module, according to yet another embodiment of the present invention.

### DETAILED DESCRIPTION

Hereinafter, a camera module according to some embodiments of the present invention, and preferred embodiments of a method of fabricating the camera module, will be described with reference to the attached drawings. The present invention may, however, be embodied in many different forms and should not be construed as being limited to the embodiments set forth herein; rather, these embodiments are provided so that this disclosure will be thorough and complete, and will fully convey the concept of the invention to those skilled in the art.

FIG. 2 is a cross-sectional view of a camera module, according to an embodiment of the present invention. Referring to FIG. 2, the camera module of the present embodiment has a novel structure in which a lens holder 150 and a FPCB 170 are attached on an upper surface of an image recognition chip 120, preferably without using a PCB. The image recognition chip 120 has a back surface, which is opposite the upper surface on which a device is formed. The back surface may not be polished. The image recognition chip 120 is a wafer level package (WLP) having a thickness of, for example, about 750 μm.

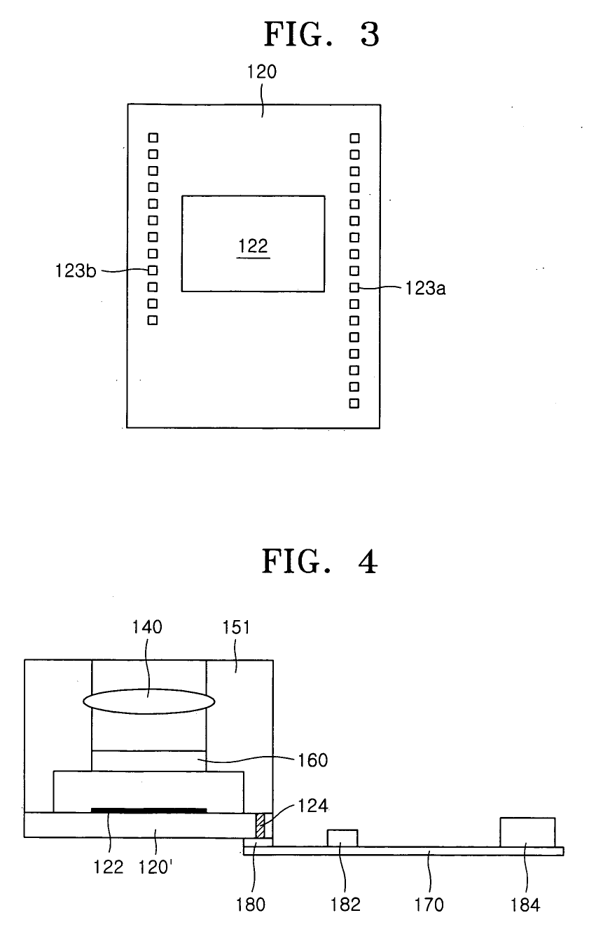

Referring to FIG. 3, an active pixel recognition (APS) 122 is formed on the upper surface of the image recognition chip 120. Also, output pads 123a are disposed on a side of the image recognition chip 120, for example, on the right side, and test pads 123b are disposed on the other side of the image recognition chip, for example, on the left side, to couple the FPCB 170 to a side of the camera module.

The lens holder 150 includes a lens 140. An additional lens (not shown) may be further installed under or over the lens 140. Also, the camera module may further comprise an IR cut filter 160 (FIG. 2). The lens holder 150 may be formed of an electromagnetic wave intercepting material such as plastic or a metallic material. The lens 140 and the IR cut filter 160 may be formed of a general glass or plastic. A lower end of the lens holder 150 may be adhered to the upper surface of the image recognition chip 120, using a conventional adhesive such as a thermosetting adhesive or a sintering adhesive that can be sintered using UV.

A side of the image recognition chip 120 protrudes beyond (or extends past) the lower end of the lens holder 150. The FPCB 170 may be attached on the upper surface of the protruding side of the image recognition chip 120 to extend outside the lens holder 150 and the image recognition chip 120. Necessary pads and/or wire patterns (not shown) may be formed on a front surface of the FPCB 170 in advance. The pads and/or wire patterns are electrically coupled to the output pads 123a of the image recognition chip 120. A passive device 182 and/or a connector 184 may be formed on the FPCB 170.

The FPCB 170 may be attached on the image recognition chip 120 using a material including, but not limited to, an ACF 180. Here, the ACF 180 may directly cover the FPCB 170 or may cover both sides of a stiffener (not shown) to adhere one side to the FPCB 170 and the other side to the image recognition chip 120. The FPCB 170 may be electrically coupled to the image recognition chip 120 using a conductive bump such as an Au bump (not shown).

A method of fabricating a camera module as shown in FIG. 2 will now be described in accordance with one embodiment of the present invention.

The FPCB 170 is attached on the upper surface of the image recognition chip 120 using the ACF 180. Next, the lower end of the lens holder 150 including the lens 140 is attached on the upper surface of the image recognition chip 120 using, for example, the thermosetting adhesive or the sintering adhesive that can be sintered by UV. Alternatively, the lower end of the lens holder 150 including the lens 140 may be attached on the upper surface of the image recognition chip 120, and then the FPCB 170 may be attached on the upper surface of the image recognition chip 120.

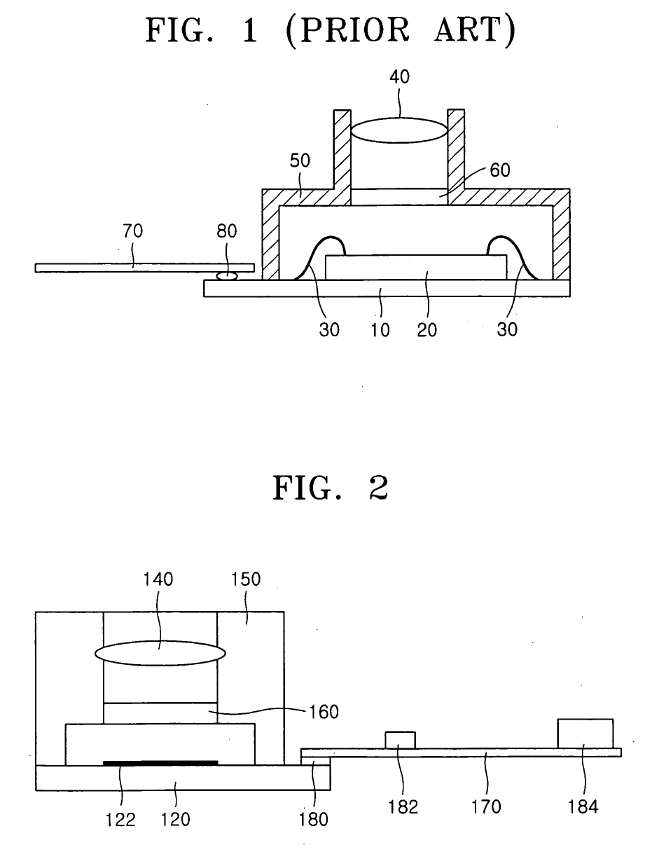

Accordingly, unlike the conventional camera module, the camera module of embodiments of the present invention does not require a PCB, and wires and chip attaching and wire bonding processes. In the conventional camera module shown in FIG. 1, the lens holder 50 must be greater than the image recognition chip 120 to allow the space for wire bonding. However, in the present embodiment, the space for wire bonding is not required. Thus, a width of the lower end of the lens holder 150 may be substantially equal to or smaller than a width of the image recognition chip 120. As a result, the camera module may not be greater than the image recognition chip 120. Therefore, the whole size of the camera module can be reduced. Also, since the camera module does not require the chip attaching and wire bonding processes, the whole process of fabricating the camera module can be simplified.

FIG. 4 is a cross-sectional view of a camera module, according to another embodiment of the present invention. The same elements of FIG. 4 as those of FIG. 2 are denoted by like reference numerals and thus will not be described herein. Here, an image recognition chip 120′ may also be a wafer level package and includes output pads disposed on a side thereof and test pads disposed on the other side thereof.

Referring to FIG. 4, a width of the image recognition chip 120′ is equal to or smaller than a width of a lens holder 151. A hole is formed in the image recognition chip 120′ and may be filled with a conductive material such as copper to form a via 124. The FPCB 170 is attached on the back surface of the image recognition chip 120′ to be electrically coupled to the image recognition chip 120′. In other words, the output pads disposed on the image recognition chip 120′ are electrically coupled to the FPCB 170 on the back surface of image recognition chip 120′ using the via 124. The image recognition chip 120′ shown in FIG. 4 may be smaller than the image recognition chip 120 shown in FIG. 2, which results in further reduction of the size of the camera module.

A method of fabricating a camera module as shown in FIG. 4 is similar to the method of fabricating the camera module as described in the previous embodiment except that the via 124 is formed before the lens holder 151 or the FPCB 170 is attached on the image recognition chip 120′.

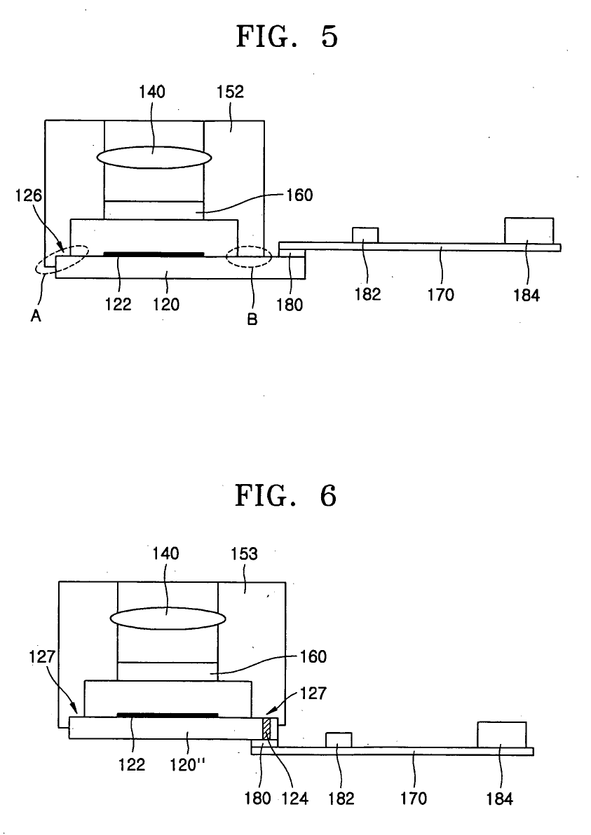

FIG. 5 is a cross-sectional view of a camera module, according to still another embodiment of the present invention. The same elements of FIG. 5 as those of FIGS. 2 and 4 are denoted by like reference numerals and thus will not be described herein.

The camera module shown in FIG. 5 is similar to the camera module shown in FIG. 2, except for the following. A lower end A, which is on an opposite side of a lower end B of the lens holder 152, has a step 126 formed therein, as shown in FIG. 5. The lower end B, which is on the side of the FPCB 170, extends to a lesser extent toward the image insulator chip 120 than the lower end A. For example, the lower end A extends past the upper surface of the image recognition chip 120 and the lower end B extends to the upper surface of the image recognition chip 120. An upper corner of the image recognition chip 120 coincides with the step 126.

Accordingly, in the present embodiment, when the lens holder 152 is assembled with, and attached on, the image recognition chip 120, the image recognition chip 120 may be inserted into the step 126 of the lens holder 152. In other words, the arrangement of elements of the camera module may be automatically determined, by shape, to conveniently perform an assembling process.

FIG. 6 is a cross-sectional view of a camera module according to yet another embodiment of the present invention. The same elements of FIG. 6 as those of FIGS. 2, 4, and 5 are denoted by like elements and thus will not be described herein. Here, an image recognition chip 120″ may also be a wafer level package and includes output pads disposed on a side thereof and test pads disposed on the other side.

The camera module shown in FIG. 6 is similar to the camera module shown in FIG. 4, except that a width of the image recognition chip 120″ is smaller than a width of a lower portion of a lens holder 153, and steps 127 may be formed within both sides of the lower portion of the lens holder 153 to match with upper corners of the image recognition chip 120″. Thus, the image recognition chip 120″ shown in FIG. 6 can be smaller than the image recognition chip 120 shown in FIG. 4. As a result, the size of the camera module of the present embodiment can be reduced significantly. Also, when the lens holder 153 is assembled with, and attached on, the image recognition chip 120″, the image recognition chip 120″ can be inserted into the steps 127 of the lens holder 153 so as to conveniently perform an assembling process.

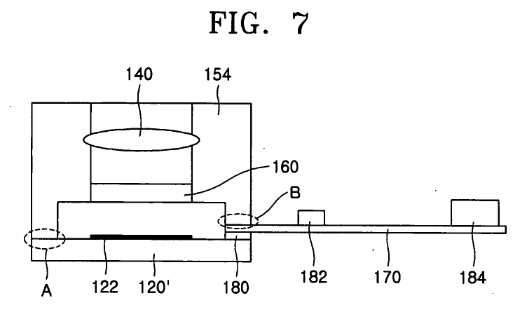

FIG. 7 is a cross-sectional view of a camera module according to yet another embodiment of the present invention. The same elements of FIG. 7 as those of FIGS. 2, 4, 5, and 6 are denoted by like reference numerals and thus will not be described herein.

Referring to FIG. 7, a width of an image recognition chip 120′ may be equal to or smaller than the width of a lower portion of a lens holder 154. The FPCB 170 is attached between a lower end B of a side of the lens holder 154 from which the FPCB 170 extends and the image recognition chip 120′. To accommodate the thickness of the FPCB 170, the lower end B of the lens holder 154 is shorter than a lower end A of the lens holder 154 opposite to the lower end B. In other words, the lower end B of the lens holder 154 to which the FPCB 170 is attached does not extend fully to the upper surface of the image recognition chip 120′ and leaves a gap between the lower end B and the image recognition chip 120′, into which the FPCB 170 and an adhesive such as the ACF 180 are inserted.

A method of fabricating a camera module as shown in FIG. 7 will now be described in accordance with one embodiment of the present invention.

The FPCB 170 is attached to the image recognition chip 120′, and then the lens holder 154 is assembled with the image recognition chip 120′. It may be seen that a gap, which is approximately as long as the thickness of the FPCB 170, is formed between the lower end B of the lens holder 154 and the ACF 180. The FPCB 170 may be seen as being inserted into the gap, and then the lens holder 154 is attached on the image recognition chip 120′. As a result, a size of the image recognition chip 120′ or a size of the camera module can be further reduced.

As described above, in a camera module according to some embodiments of the present invention, a lens holder and a FPCB can be directly attached on an image recognition chip without using a PCB. Thus, cost can be reduced by at least the price of the PCB. Also, a size of the camera module can be reduced. A method of fabricating the camera module of embodiments of the present invention can exclude chip attaching and wire bonding processes. Thus, the camera module can be fabricated within a short time using a simple assembling process.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A camera module comprising:
a lens holder comprising a lens, the lens holder having a first lower end and a second lower end;
an image recognition chip comprising an upper surface and a back surface opposite the upper surface, the upper surface attached to at least one of the first and second lower ends; and
a flexible printed circuit board attached on the image recognition chip to extend outside the lens holder and the image recognition chip.

2. The camera module of claim 1, wherein a side of the image recognition chip protrudes beyond at least one of the first and second lower ends, and the flexible printed circuit board is attached on an upper surface of the protruding side of the image recognition chip.

3. The camera module of claim 2, wherein the image recognition chip is a wafer level package.

4. The camera module of claim 2, wherein the image recognition chip comprises output pads disposed on the protruding side and test pads disposed on a side opposite to the protruding side.

5. The camera module of claim 4, wherein the output pads are electrically coupled to the flexible printed circuit board.

6. The camera module of claim 2, wherein the first lower end of the lens holder, which is on a side of the image recognition chip opposite to the protruding side of the image recognition chip, is longer than the second lower end of the lens holder on the protruding side of the image recognition chip, and a step is formed inside the first lower end to coincide with an upper corner of the image recognition chip.

7. The camera module of claim 1, wherein a width of the image recognition chip is equal to or smaller than a width of the lower portion of the lens holder, wherein the flexible printed circuit board attached on the lower surface of the image recognition chip is electrically coupled to the image recognition chip through a via extending therethrough.

8. The camera module of claim 7, wherein the image recognition chip comprises output pads disposed on the protruding side and test pads disposed on a side opposite to the protruding side, and the output pads are electrically coupled to the flexible printed circuit board using the via.

9. The camera module of claim 8, wherein a width of the image recognition chip is smaller than a width of the lower portion of the lens holder.

10. The camera module of claim 1, wherein a pair of steps opposite to each other are formed inside the lower portion of the lens holder to coincide with upper corners of the image recognition chip.

11. The camera module of claim 1, wherein the flexible printed circuit board is located between the lens holder and the image recognition chip.

12. The camera module of claim 11, wherein one of the first and second lower ends of the lens holder is attached to the flexible printed circuit board and extends to a lesser extent toward the image recognition chip than an opposite lower end of the lens holder to accommodate a thickness of the flexible printed circuit board.

13. The camera module of claim 11, wherein a width of the image recognition chip is not greater than a width of the lower portion of the lens holder.

14. The camera module of claim 1, wherein the one of the first and second lower ends of the lens holder is attached on the upper surface of the image recognition chip using an adhesive.

15. A method of fabricating a camera module, comprising:
attaching a flexible printed circuit board on an upper or lower surface of an image recognition chip to extend in a direction away from the image recognition chip;
preparing a lens holder comprising a lens, the lens holder having a first lower end and a second lower end; and
attaching at least one of the first and second lower ends of the lens holder on the upper surface of the image recognition chip.

16. The method of claim 15, wherein a first side of the image recognition chip protrudes beyond one of the first and second lower ends of the lens holder, and the flexible printed circuit board is attached on the first side of the image recognition chip.

17. The method of claim 16, wherein the second lower end of the lens holder on a second side of the image recognition chip opposite to the first side of the image recognition chip is longer than the first lower end of the lens holder on the first side of the image recognition chip, and a step is formed inside the second lower end of the lens holder to coincide with an upper corner of the image recognition chip to insert the upper corner of the image recognition chip into the step.

18. The method of claim 15, wherein a width of the image recognition chip is equal to or smaller than a width of the lower portion of the lens holder, a via is formed through the image recognition chip, and the flexible printed circuit board attached on the lower surface of the image recognition chip is electrically coupled to the image recognition chip using the via.

19. The method of claim 15, wherein a width of the image recognition chip is smaller than a width of the lower portion of the lens holder, and steps are formed inside one of the first and second lower ends of the lens holder to coincide with upper corners of the image recognition chip and to insert the upper corners of the image recognition chip into the steps.

20. The method of claim 15, wherein the flexible printed circuit board is attached between one of the first and second lower ends of the lens holder from which the flexible printed circuit board extends and the image recognition chip.

21. The method of claim 20, wherein one of the first and second lower ends of the lens holder to which the flexible printed circuit board is attached is shorter than the other lower end of the lens holder to accommodate a thickness of the flexible printed circuit board.

22. The method of claim 20, wherein a width of the image recognition chip is equal to or smaller than a width of the lower portion of the lens holder.

23. The method of claim 15, wherein the one of the first and second lower ends of the lens holder is attached on the upper surface of the image recognition chip using an adhesive.

24. The method of claim 15, wherein the flexible printed circuit board is attached to the image recognition chip using an anisotropic conductive film.

25. A method of fabricating a camera module, comprising:
preparing a lens holder comprising a lens;
attaching a lower end of the lens holder on an upper surface of an image recognition chip; and
attaching a flexible printed circuit board on the upper or a lower surface of the image recognition chip.
